(19) United States
(12) Patent Application Publication
(10) Pub. No.: US 2015/0268962 A1
(43) Pub. Date: Sep. 24, 2015

(54) Asynchronous Circuit Design

(71) Applicant: GoofyFoot Labs, Plano, TX (US)

(72) Inventors: Nisha Checka, Plano, TX (US); Christopher David Shirk, Plano, TX (US)

(21) Appl. No.: 14/223,168

(22) Filed: Mar. 24, 2014

(51) Int. Cl. G06F 9/38; G06F 15/76

(52) U.S. Cl. CPC G06F 9/3867; G06F 15/76; G06F 9/3871

(57) ABSTRACT

An asynchronous circuit that implements a dual pipeline stage is disclosed. The input stage of the circuit receives asynchronous data. A first converter separates the data from the input stage into alternating pipelines to allow parallel execution. A second converter then merges the data from the dual pipelines back into a single output stage. This technique is useful in improving the speed of a circuit, as it allows parallel execution. In other embodiments, the dual pipelines offer fault tolerance. In some embodiments, the protocol used in the input and output stages is different from that employed in the dual pipelines.

### BACKGROUND

Synchronous circuit design has been used for many years to implement complex designs, such as microprocessors, controllers and other sophisticated logic functions. Synchronous design allows the certainty of predictable circuit operation, in that a global clock signal is typically used to control all of the storage elements in the device. In this way, the timing within the design is well understood. Design rules are also relatively straight-forward: The propagation delay of the combinational logic that is disposed between two pipelined storage elements must be less than the period of the global clock. Automated design tools have been created to help enforce this simple rule.

While synchronous circuit design may be straightforward, often, there are drawbacks associated with it. First, the maximum clock frequency is determined based on the greatest combinational logic delay found in the entire design. This fact limits, in some cases, the maximum speed of the device, which may be unacceptable. In other cases, this fact limits the amount of combinatorial logic that can be disposed between two pipeline stages, thereby requiring more pipelined stages to achieve the desired function, which may also be unacceptable. Secondly, the use of a global clock also has significant power consumption implications. The power required to switch a global clock signal, which feeds hundreds, or even thousands, of transistors is significant. Furthermore, the power consumed by synchronous circuits generally increases as the clock frequency increases. Thus, very high speed circuits may consume unacceptable amounts of power.

Therefore, a different technology which allows high speed circuit design, but does not have the drawbacks listed above would be beneficial.

### SUMMARY

An asynchronous circuit that implements a dual pipeline stage is disclosed. The input stage of the circuit receives asynchronous data. A first converter separates the data from the input stage into alternating pipelines to allow parallel execution. A second converter then merges the data from the dual pipelines back into a single output stage. This technique is useful in improving the speed of a circuit, as it allows parallel execution. In other embodiments, the dual pipelines offer fault tolerance. In some embodiments, the protocol used in the input and output stages is different from that employed in the dual pipelines.

### BRIEF DESCRIPTION OF THE FIGURES

For a better understanding of the present disclosure, reference is made to the accompanying drawings, which are incorporated herein by reference and in which:

FIG. 1 shows a timing diagram for a first type of asynchronous communication;

FIG. 2 shows a timing diagram for a second type of asynchronous communication;

FIG. 3 shows a timing diagram for a third type of asynchronous communication;

FIG. 4 shows a representative block diagram for an asynchronous device;

FIG. 5A is a representative schematic for a dual pipeline architecture;

FIG. 5B is a representative timing diagram showing the conversion from 4-phase data to dual pipeline architecture;

FIG. 5C is a representative timing diagram showing the merge of dual pipeline architecture to 4-phase data;

FIG. 5D is a representative timing diagram showing the conversion from 2-phase data to dual pipeline architecture;

FIG. 5E is a representative timing diagram showing the merge of dual pipeline architecture to 2-phase data;

FIG. 6A shows an error detection circuit according to a first embodiment;

FIG. 6B is a representative timing diagram associated with the circuit of FIG. 6A;

FIG. 7A shows an error detection circuit according to a second embodiment; and

FIG. 7B is a representative timing diagram associated with the circuit of FIG. 7A.

### DETAILED DESCRIPTION

Asynchronous circuit design refers to circuit designs which operate without the use of a clock signal. In many cases, data is generated at a first stage and presented to a second stage. When this data is valid, the first stage provides some indication of its validity. This alerts the second stage that it may accept and use this new data. The second stage then typically returns an indication to the first stage that it has received this data, and the first stage is free to remove it.

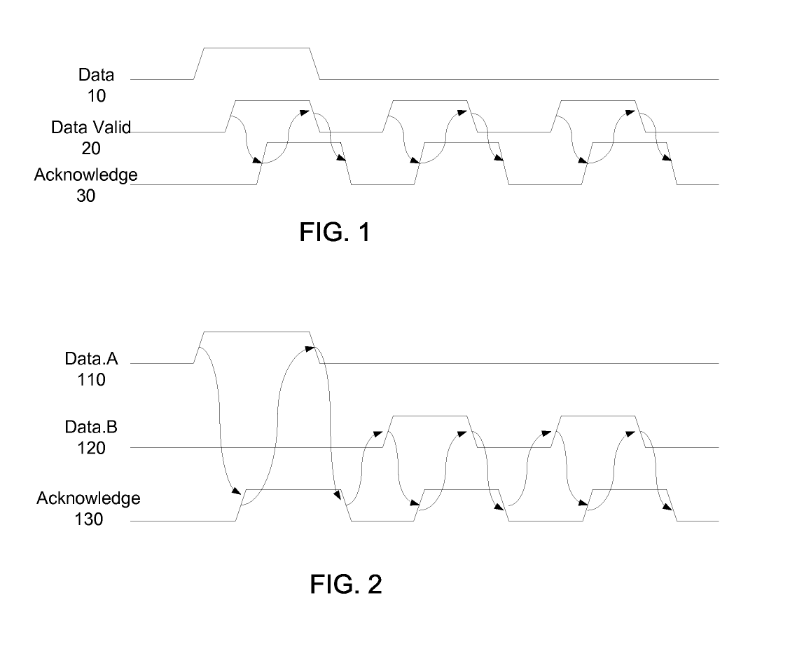

FIG. 1 shows a single handshake protocol involving a data signal 10, an acknowledge signal 30, and a data valid signal 20. In this example, the data signal 10 may be a single bit. However, in other embodiments, a group of data bits may be associated with a single data valid signal 20. Once the data signal 10 is stable, the data valid signal 20 is asserted. Upon receipt of the data valid signal 20, the second stage accepts the new data, and asserts the acknowledge signal 30, indicating that the data has been accepted. The assertion of the acknowledge signal 30 causes the deassertion of the data valid signal 20, and indicates that the first stage may change the data signal 10. The deassertion of the data valid signal 20 causes the deassertion of the acknowledge signal 30. Once the new data is available at the output of the first stage, the data valid signal 20 is again asserted, and the cycle described above repeats. In the cycle shown in FIG. 1, the data pattern (1,0,0) is asynchronously communicated from the first stage to the second stage.

While FIG. 1 shows asynchronous communication using a data valid and acknowledge signal, other mechanisms are used. For example, in some embodiments, one bit of data is represented by 2 or more signal lines, and the state of those signals can be used to indicate the value of the data bit, as well as its status. One such protocol is shown in FIG. 2. In this figure, a return-to-zero protocol is used, and 2 signals are used to represent one bit of data. The following table shows the encoding of these signals:

TABLE 1

| Signal A | Signal B | Meaning |
|---|---|---|
| 0 | 0 | Data not ready; spacer |
| 0 | 1 | Data ready; data = 0 |
| 1 | 0 | Data ready; data = 1 |
| 1 | 1 | Not used |

FIG. 2 shows one bit of data encoded using two signals Data.A 110 and Data.B 120. An acknowledge signal 130 is used by the downstream stage to indicate that this data has been received. FIG. 2 shows the same data pattern as was shown in FIG. 1. First Data.A is asserted. This assertion causes the second stage to assert the acknowledge signal 130. The assertion of this acknowledge signal 130 causes Data.A to be deasserted, thus returning the data (i.e. Data.A:Data.B) to the (0:0) state. This state is also referred to as the spacer state, as no data is being transferred at this time, and this state provides space between the data bits. Once the data has returned to the (0:0) state, the acknowledge signal 130 is deasserted. This cycle can then be repeated for each subsequent data bit. In some embodiments, the protocol shown in FIG. 2 is preferred, as the circuit design required to implement this approach is very efficient and straightforward. This technique, while straightforward, requires two round trip delays to transfer one bit of data. Specifically, the data is presented, the acknowledge signal is asserted, the data is removed, and the acknowledge signal is deasserted. It is only then that new data can be presented.

In some embodiments, more than 1 data bit is transferred per transfer. For example, in some embodiments, 2 data bits are encoded using 4 signals, such that only one signal changes when transitioning between any two pairs of data values. This can be increased to 3 data bits using 8 signals, or other combinations.

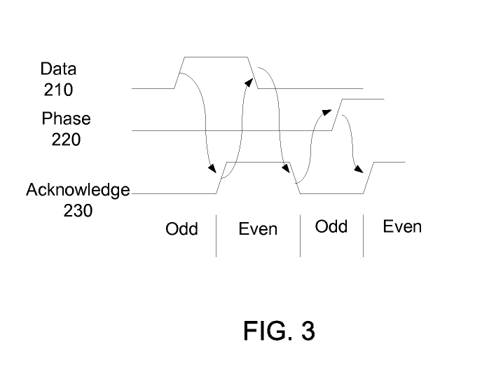

FIG. 3 shows an asynchronous transfer protocol. In this embodiment, only one round trip delay is used to transfer data between stages. Specifically, in one embodiment, the data bit is encoded in 2 or more signals. These two signals operate in conjunction with the acknowledge to define data state and status. While this may be done in many ways, one such technique is shown in FIG. 3. In this embodiment, one of these signals is referred to as the data signal 210, while the second may be referred to as the phase signal 220. The combination of the data signal 210, the phase signal 220 and the acknowledge signal 230 can be used to define the status of the data. For example, in one embodiment, the data signal 210 always represents the value of the data bit. The phase signal 220 serves as a parity bit when viewed in combination with the data signal 210 and the acknowledge signal 230. Specifically, when the acknowledge signal 230 is low, the data signal 210 and the phase signal 220 employ odd parity to signify valid data. Conversely, when the acknowledge signal 230 is high, the data signal 210 and the phase signal 220 employ even parity to signify valid data. Of course, the opposite convention may also be used. Stated differently, the data is valid when the data signal 210, the phase signal 220 and the acknowledge signal 230, when viewed as a group, have a certain parity.

FIG. 3 shows the transfer of data between two stages and the parity used during each data transfer. Note that the same data pattern (1,0,0), used in FIGS. 1 and 2, is transferred in FIG. 3. However, less time and signal transitions are required in this embodiment. Typically, this protocol, also referred to as 2-phase level-encode dual-rail (LEDR), only allows exactly one of the data signal 210 and the phase signal 220 to transition during each data transfer. Note that because data is transferred at each transition of the acknowledge signal 230, data can be transferred more quickly using the LEDR protocol. However, the logic and circuitry required to implement LEDR is not as straightforward as the 4-phase approach shown in FIG. 2. Although this disclosure uses the term “2-phase LEDR”, it is understood that this term also encompasses all other 2-phase protocols, such as LETR, and others. Thus, the terms “2-phase protocol” and “2-phase LEDR” are used interchangeable.

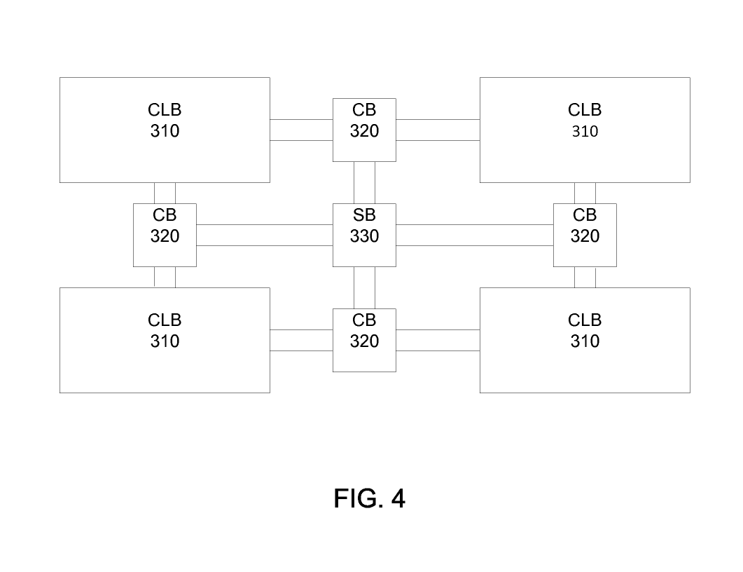

Asynchronous circuits may be deployed in any type of logic circuit, including but not limited to application specific integrated circuits (ASICs), custom devices, processors, and a field programmable gate array (FPGA). Some of these devices, such as the FPGA, may utilize a structure that includes configurable logic blocks (CLBs), which are interconnected using Connection Blocks (CB) and Switching Blocks (SB), as shown in FIG. 4. The CLBs 310 include logic functions, such as AND, OR, and ADD, although other logic functions may also be implemented. In some embodiments, the CLB 310 includes at least a look up table (LUT), which allows any logic function to be implemented, an adder, and output buffers. The outputs from the CLBs 310 are routed using wires to a CB 320. The CB 320 is simply is programmable fuse matrix that allows connection of an input from a CLB 310 to the switching matrix. The CBs 320, as suggested above, may simply be fuses; thus, no pipelining may be performed in the CB 320. These CBs 320 then connect to SBs 330. The SB 330 serves as a switchboard to route the outputs from one particular output CLB 310 to the designated input CLB 310, typically via one or more SBs 330. In some embodiments, the SB 330 only serves to connect an input path to an output path. In other embodiments, the SB 330 may contain one or more storage stages to pipeline the data between the CLBs 310. For example, each SB 330 may include one or more pipeline stages. This may improve overall speed when signals are routed long distances in the device.

Traditionally, data moves through the FPGA in a single pipeline. In other words, data is processed in a CLB 310, and then that data is transferred, using CBs 320 and SBs 330, to another CLB 310, where it is further processed. In some embodiments, the CLBs 310 may be a source of several design concerns. For example, the combinational logic disposed in a CLB 310 may be significant and may, in some embodiments, limit the overall speed or data throughput of the entire FPGA. Therefore, to overcome this limitation, the present disclosure describes the incorporation of dual pipelines within every CLB 310 In other embodiments, it may be important to minimize or eliminate errors caused by spurious radiation. Therefore, to overcome this limitation, the present disclosure, describes the incorporation of dual pipelines, in the CLB, SB and CB. These dual pipelines may operate out of phase, such that, when operating in 4-phase mode, the first pipeline is processing data, while the second pipeline is processing a spacer. This may lead to a more consistent temporal power consumption profile and may reduce the chances of non-recoverable errors caused by spurious radiation. Of course, the dual pipelines may also be operating in phase with each other if desired.

While some embodiments are described in reference to a FPGA, it should be noted that the techniques described herein, such as dual pipelining, are equally applicable to any type of logic circuit. For example, in some embodiments, an integrated circuit may not have separate CLBs and routing elements. In some of these embodiments, the dual pipeline technique may be implemented throughout the circuit. In other embodiments, the dual pipeline technique may also be utilized in certain portions of the circuit.

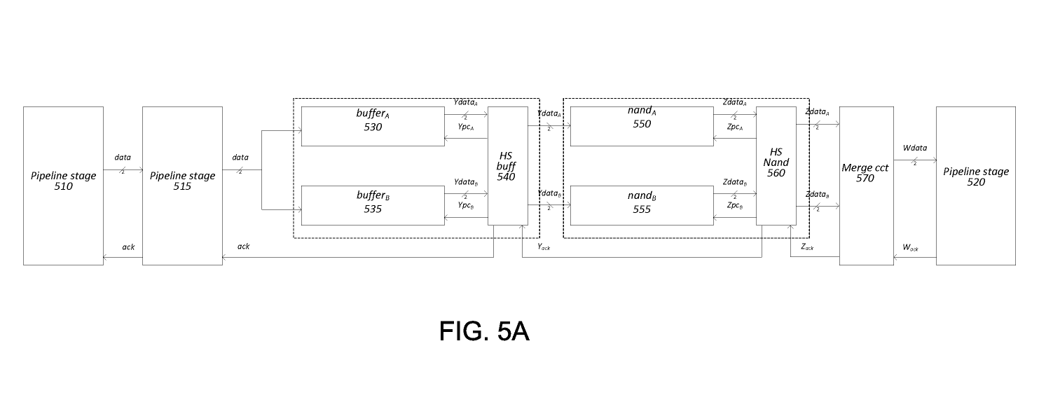

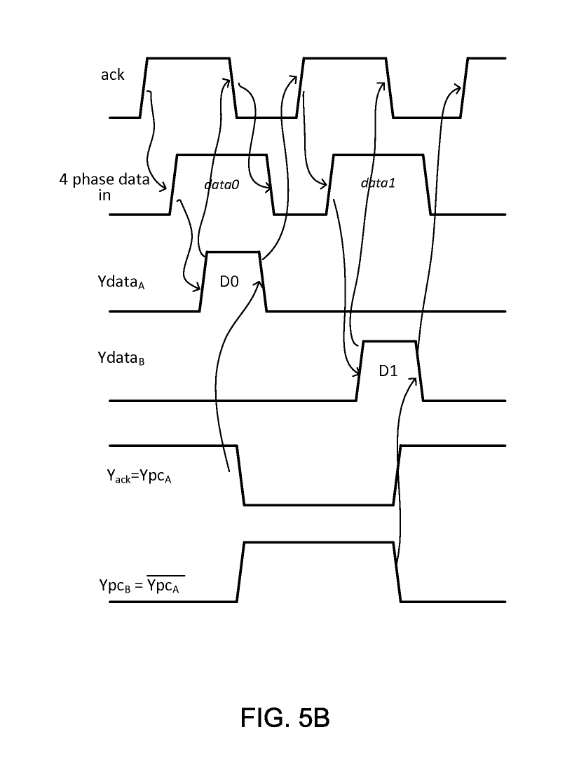

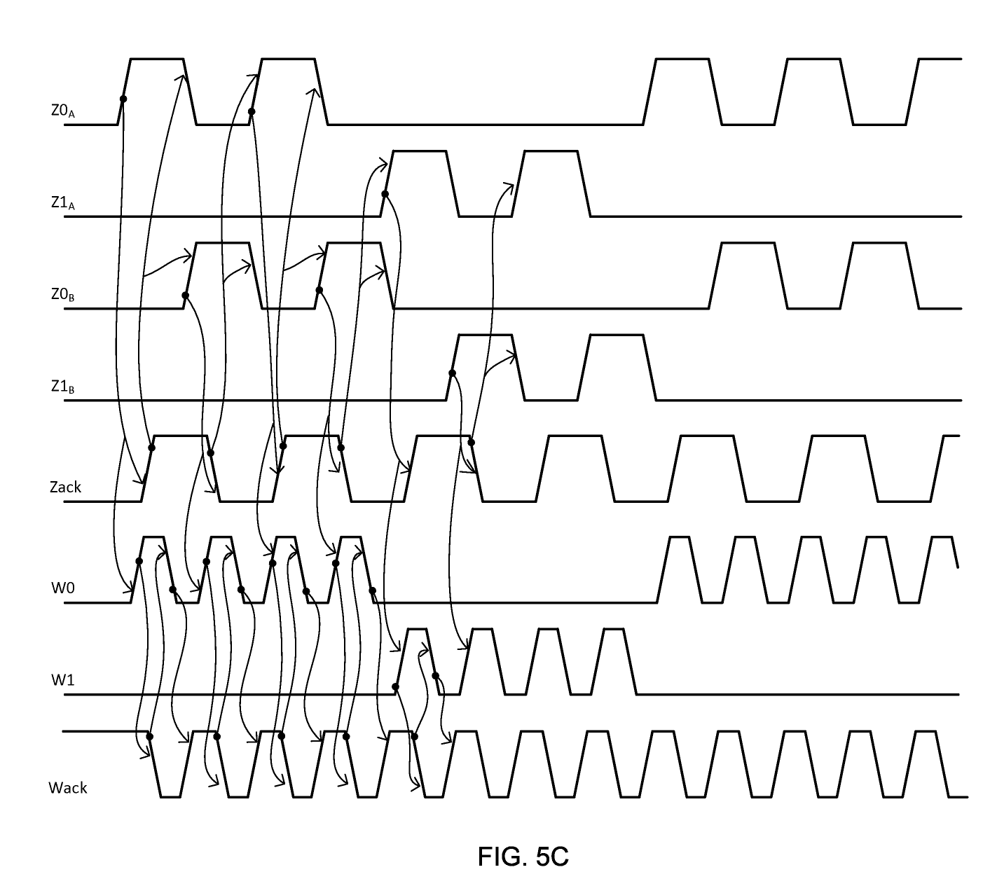

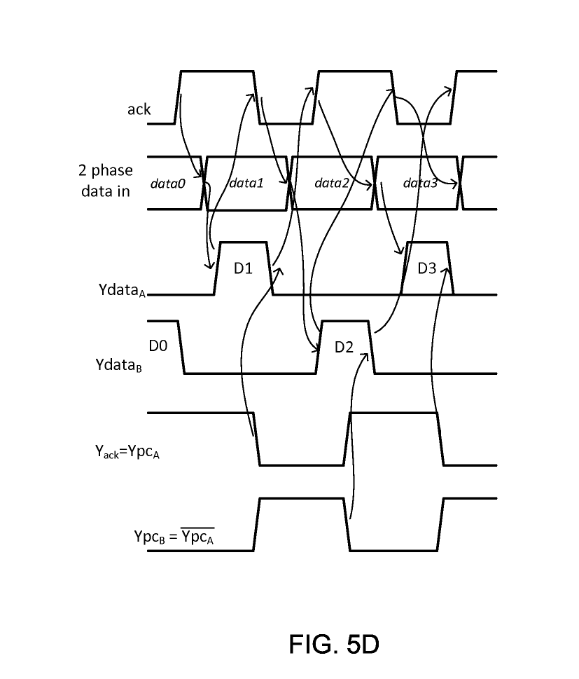

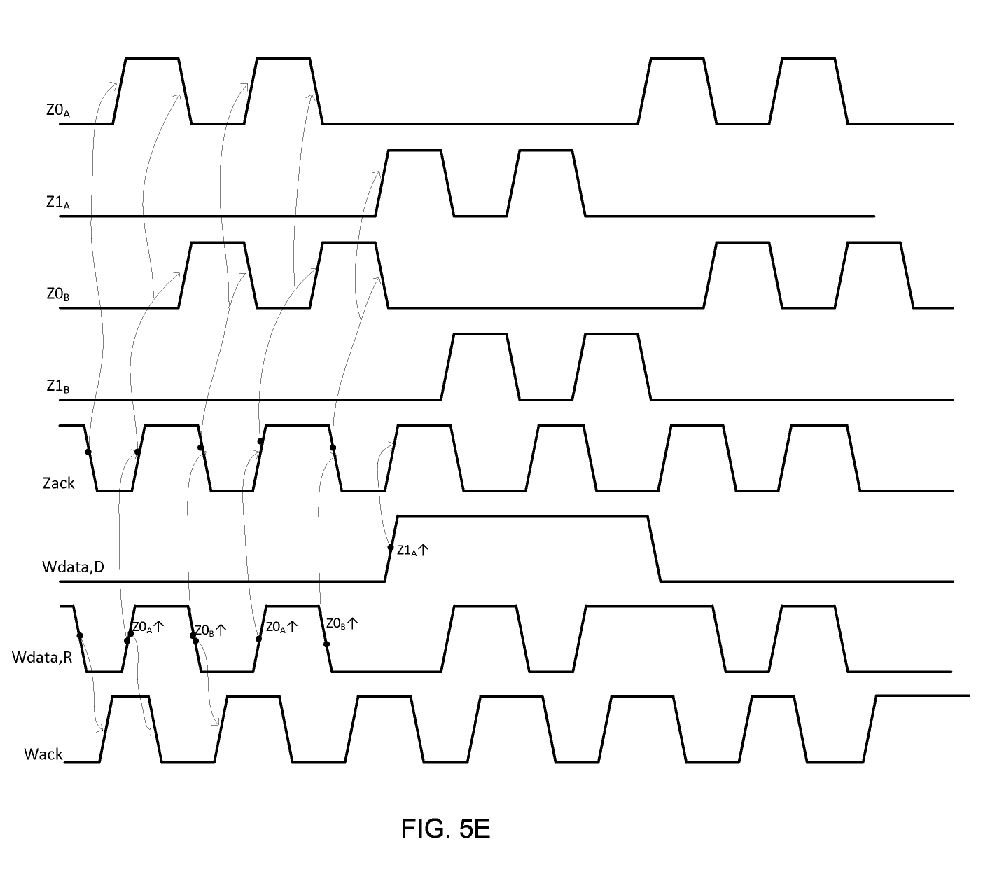

FIG. 5A shows a representative diagram of the internal design of a sample asynchronous circuit. In this embodiment, the buffer 530, 535 and nand 550, 555 may be the rate limiting components of the circuit. Therefore, the use of dual pipelines may serve to increase the overall speed of the device. FIG. 5B shows a timing diagram, according to one embodiment, where 4-phase signals are used throughout the system. In other words, in this embodiment, the incoming 4-phase signal is separated into two pipelines, which operate out of phase with one another and use the 4-phase protocol.

Pipeline stages 510, 515 transfer data using an acknowledge signal. The output of pipeline stage 515 is in communication with a buffer, which, as described above, utilizes a dual pipeline. The data from the second pipeline stage 515 is duplicated and enters two buffers 530, 535. This data is referred to as “4 phase data in” in the timing diagram of FIG. 5B. The HS buffer 540 is the handshaking circuit for the buffer. It generates pre-charge signals that indicate which of the dual pipelines 530,535 is active, and which is processing a spacer. When the pre-charge signal is low, the dual pipeline stage associated with that pre-charge signal is processing a spacer.

When the pre-charge signal is high, the associated stage is processing data. The handshaking circuit 540 generates the pre-charge signals such as Ypc_{A} and Ypc_{B} are inverses so that when Ypc_{A} is high, Ypc_{B} is low, and vice versa. The handshaking stage 540 sends the acknowledge signal back to the previous pipeline stage 515.

Referring to FIG. 5B, it can be seen that when new 4 phase data (data0) becomes available, it is transferred into the first dual pipeline 530 as Ydata_{A}(D0). Its presence as Ydata_{A} causes an ack to be deasserted by HS buffer 540. The deassertion of the ack causes the 4-phase data in (data0) to enter transmit a spacer and also causes the precharge signal for the first pipeline (Ypc_{A}) to become deasserted by the HS buffer 540. The deassertion of the first precharge signal indicates that the Ydata_{A} has been transferred to the HS buffer 540, thereby allowing the Ydata_{A} (D0) to be changed to the spacer state. The presence of the spacer at Ydata_{A} causes the assertion of the ack signal from the HS buffer 540 to the pipeline stage 515. The assertion of the ack signal causes the pipeline stage 515 to present the next 4-phase data (data1). This new data is transferred to the second dual pipeline 535 as Ydata_{B}(D1). The second pipeline is selected based on the state of the precharge signals Ypc_{A} and Ypc_{B}. Once D1 is stable as Ydata_{B}, the ack is deasserted by the HS buffer 540. This then causes the precharge signal Ypc_{B} to become deasserted. The deassertion of the precharge signal Ypc_{B} then allows the Ydata_{B} (D1) to be changed. The removal of D1 causes the ack to be asserted by the HS buffer 540 to the pipeline stage 515. The process shown in FIG. 5B can now be repeated. Note that in this embodiment, the HS buffer 540 and the two pipelines 530, 535 serve to demultiplex the incoming data, so that the incoming data elements are alternated between the two pipelines. To maintain the throughput of the system, the logic in each dual pipeline paths can actually operate at half the speed of the non-pipelined logic so that when both dual pipelines work in tandem, their effective throughput matches the surrounding logic. Thus this technique is useful in speeding up critical paths.

Because of the dual pipeline stage, there are now two data paths, A and B. Since the next stage 550, 555 is also a dual pipeline stage, the two data paths feed directly into the dual pipelines 550, 555. This stage 550, 555 may contain more complex circuitry, such as multipliers, a lookup table, shifters, etc. Although any combinatorial function may be included in stage 550, 555, this stage is referred to as ‘nand’ in FIG. 5A to signify that a nand logic function is being performed in this example. The ‘HS nand’ circuit 560 performs the same function as the previous stage in controlling which dual pipeline stage is actively processing data and which is processing the spacer through the pre-charge signals (Zpc_{A}, Zpc_{B}).

The pipeline stage 520 does not use dual pipelines so the two data streams have to be merged into a single data stream. The merge circuit 570 is another pipeline stage that merges the two data streams. This merge circuit 570 interfaces between the standard pipeline stages 520 and the dual pipeline stages 560.

FIG. 5C shows a representative timing diagram showing how this merge function is achieved. Z0_{A} and Z1_{A} represent Zdata_{A}, Z0_{B} and Z1_{B} represent Zdata_{B}, and W0 and W1 represent Wdata, as seen in FIG. 5A. The assertion of new Zdata_{A} causes the assertion of Zack and also allows the transfer of the new data to Wdata. The assertion of Zack then causes the Zdata_{A} to transition to a spacer. Furthermore, the assertion of Zack also causes the presentation of Zdata_{B}. The new Zdata_{B} causes the deassertion of Zack and allows the transfer of the new data to Wdata. The deassertion of Zack causes Zdata_{B} to transition to a spacer and allows new data to be presented on the Zdata_{A}. In other words, in this embodiment, the first pipeline (Zdata_{A}) presents data when the Zack signal becomes deasserted and transitions to the spacer when the Zack signal is asserted. The Zack signal is asserted by the presentation of new data on Zdata_{A}. Conversely, the second pipeline (Zdata_{B}) presents data when the Zack signal is asserted and transitions to the spacer when the Zack signal is deasserted. The Zack signal is deasserted by the presentation of new data on Zdata_{B}.

The Wdata signal transitions whenever new data is presented on either Zdata_{A} or Zdata_{B}. The presentation of new data on Wdata causes Wack to become deasserted. The deassertion of the Wack signal then causes the Wdata to transition to the spacer state. The transition to the spacer state causes the assertion of the Wack signal. In other words, every transition of Wdata causes a transition of Wack and every transition of Wack causes a transition of Wdata. This results in the Wdata transitioning at twice the frequency of Zdata_{A} and Zdata_{B}.

In some embodiments that use an FPGA, the pipeline stages 510, 515, 520 may be disposed in the SB elements of the device (see FIG. 4), while the dual pipeline is disposed in the CLB. In other embodiments, the dual pipeline stages may also be utilized in the SB elements. In other circuits, the dual pipeline circuit may be disposed in any part of the circuit where the speed improvement that accompanies dual pipelining is required.

Also, in some embodiments, the nand 550 is actively processing data, while nand 555 is processing a spacer. Similarly, nand 550 is processing a spacer while nand 555 is processing data. Thus, the dual pipeline approach shown in FIG. 5A creates spatial separation of the two sets of data (i.e. there are two distinct data paths), and also creates temporal separation of the two sets of data (since processing of the two pipelines is performed out of phase).

The circuit of FIG. 5A offers various advantages. First, by utilizing dual pipelines, twice as much data can be processed in a given time, thereby increasing the overall throughput of the circuitry. Other particular embodiments are also made possible through the use of dual pipelines.

Speed

First, as described above, speed of the circuit can be improved through the use of dual pipelines. This speed benefit can be exploited in other ways as well.

For example, traditionally, only one asynchronous protocol is used throughout the entire FPGA. In other words, if the 4-phase approach is used in the CLBs due to the ease of circuit implementation, then the 4-phase approach is also used for communication between the CLBs. However, as explained above, the 4-phase approach is desirable due to the simplicity of circuit design, but undesirable due to the two round trip delays. Thus, in one embodiment, the present disclosure includes an asynchronous circuit design having CLBs that employ dual pipelines utilizing the 4-phase approach for internal logic functions. However, the interfaces to and from the CLBs translate this protocol to a 2-phase LEDR protocol, due to the increased speed of transfer. The Switch Blocks also utilize the 2-phase LEDR protocol.

As described above, FIG. 5A shows a representative diagram of the internal design of the asynchronous circuit. In one embodiment, certain components of the FPGA may use 2-phase LEDR protocol, while other portions utilize 4-phase communication. The diagram shown in FIG. 5A can be used in this embodiment as well. For example, pipeline stages 510, 515 employ a 2-phase protocol with an acknowledge signal. In the case of a FPGA, the output of pipeline stage 515 may be in communication with a CLB, which, as described above, utilizes a 4-phase protocol. Of course, the conversion from 2-phase to 4-phase dual pipelined architecture may be used in any type of asynchronous circuit. The description regarding FPGAs is only illustrative of one possible embodiment.

The second pipeline stage 515 converts incoming 2-phase data to a 4-phase data stream that is input into the dual pipelines 530, 535. As described above, the HS buffer 540 is the handshaking circuit for the buffer. It generates pre-charge signals that indicate which of the dual pipelines 530,535 is active, and which is processing a spacer. The handshaking circuit 540 generates the pre-charge signals such that Ypc_{A} and Ypc_{B} are inverses so that when Ypc_{A} is high, Ypc_{B} is low, and vice versa. The handshaking stage 540 sends the acknowledge signal back to the previous pipeline stage 515.

FIG. 5D shows the use of dual pipelines where the incoming data is 2-phase LEDR protocol and the pipelines operate using 4 phases. When new 2 phase Adata (data1) becomes available, pipeline 515 converts the data to 4-phase and transfers the data into the first dual pipeline 530 as data_{A} (D1). Stage 530 evaluates data_{A} and outputs Ydata_{A}. The presence of Ydata_{A} causes an ack to be deasserted by HS buffer 540. The deassertion of the ack signal causes the pipeline stage 515 to convert the next 2-phase data (data2) into 4-phase dual pipeline data, data_{B} (D2). The deassertion of the ack also causes the 2-phase data (data1) to be removed and also causes the precharge signal for the first pipeline (Ypc_{A}) to become deasserted by the HS buffer 540. The deassertion of the first precharge signal indicates that the Ydata_{A} has been transferred to the HS buffer 540, thereby allowing the Ydata_{A} (Y1) to be changed. The changing of the Ydata_{A} causes the assertion of the ack signal from the HS buffer 540 to the pipeline stage 515. The new data dataB (D2) is transferred to the second dual pipeline pipeline 535 causing it to evaluate and present Ydata_{B}(Y2). The second pipeline is selected based on the state of the precharge signals Ypc_{A} and Ypc_{B}. Once Y2 is stable as Ydata_{B}, the ack is deasserted by the HS buffer 540. This then causes the precharge signal Ypc_{B} to become deasserted. The deassertion of precharge signal Ypc_{B} then allows the Ydata_{B} (Y2) to be changed. The transition from Y2 to the spacer state causes the ack to be asserted by the HS buffer 540 to the pipeline stage 515. The process shown in FIG. 5D can now be repeated. Note that in this embodiment, the HS buffer 540 and the two pipelines 530, 535 serve to demultiplex the incoming data, so that the incoming data elements are alternated between the two pipelines. To maintain the throughput of the system, the logic in each of the dual pipeline paths, which use the 4 phase signaling protocol, can actually operate at half the speed of the non-dual pipelined logic. Thus this technique is useful in allowing the 4 phase logic to operate at the same rate as the 2 phase LEDR protocol used in the surrounding blocks.

The pipeline stage 570 serves to merge the two data streams into a single data stream, where the single data stream utilizes 2-phase LEDR protocol.

FIG. 5E shows a representative timing diagram showing how this merge function is achieved. Z0_{A} and Z1_{A} represent Zdata_{A}, Z0_{B} and Z1_{B} represent Zdata_{B}, and Wdata_{D} and Wdata_{R} represent Wdata, as seen in FIG. 5A. The assertion of new Zdata_{A} allows the transfer of the new data to Wdata, which in turn causes the assertion of Zack. The assertion of Zack then causes the Zdata_{A} to transition to a spacer. Furthermore, the assertion of Zack also causes the presentation of Zdata_{B}. The new Zdata_{B} allows the transfer of the new data to Wdata, which in turn causes the deassertion of Zack. The deassertion of Zack causes Zdata_{B} to transition to a spacer and allows new data to be presented on the Zdata_{A}. In other words, in this embodiment, the first pipeline (Zdata_{A}) presents data when the Zack signal becomes deasserted and transitions to the spacer when the Zack signal is asserted. The Zack signal is asserted by the presentation of new data on Wdata. Conversely, the second pipeline (Zdata_{B}) presents data when the Zack signal is asserted and transitions to the spacer when the Zack signal is deasserted. The Zack signal is deasserted by the presentation of new data on Wdata.

The presentation of new data on Wdata causes a transition in Wack. In other words, whenever Wdata changes because of new data on Zdata_{A}, the Wack signal is deasserted. Whenever Wdata changes because of new data on Zdata_{B}, the Wack signal is asserted. Thus, with respect to the dual pipelines 560, the merge circuit 570 operates in a similar fashion as that shown in FIG. 5C. However, the interface between the merge circuit 570 and pipeline stage 520 is much different than that described in FIG. 5C.

Thus, the pipeline stage 515 forms a first converter at the input to the dual pipeline stages, which serves to convert the data, such as 2-phase LEDR signals or 4-phase signals, to dual pipelined data, such as 4-phase signals. Similarly, the merge circuit 570 forms a second converter, disposed at egress side of the dual pipeline stages, which converts the dual pipelined data back to a single output stage, which may utilize 2-phase LEDR format or 4-phase signals.

Thus, in one embodiment, a field programmable gate array (FPGA) is disclosed which utilized 2-phase LEDR to communicate between configurable logic blocks (CLBs) for speed. The CLBs include first converters at the inputs to translate from 2-phase LEDR to the 4-phase approach. The CLBs also include second converters to the outputs to translate from the 4-phase approach back to 2-phase LEDR. Within the CLBs, and between the first and second converters, dual pipeline data paths are disposed, each operating out of phase with the other and utilizing the 4-phase approach. Thus, processing within the CLB occurs with data using the 4-phase approach, while communication between CLBs occurs using 2-phase LEDR.

In another embodiment, an asynchronous circuit is disclosed, where a portion of the circuit operates using 2-phase LEDR protocol, and a second portion operates using 4-phase protocol. In this embodiment, first converters are used to translate from the 2-phase LEDR protocol to dual pipelined 4-phase protocol. Second converters are utilized to translate the dual pipelined 4-phase data back to 2-phase LEDR format.

Fault Tolerance

A second consideration in the design of any circuit is its tolerance to errors. Errors may occur due to many causes, such as the exposure to radiation. Radiation is known to cause a change in the state of a transistor in a circuit. If one, or a limited number of transistors is affected, it is possible to tolerate the error and recover the original data.

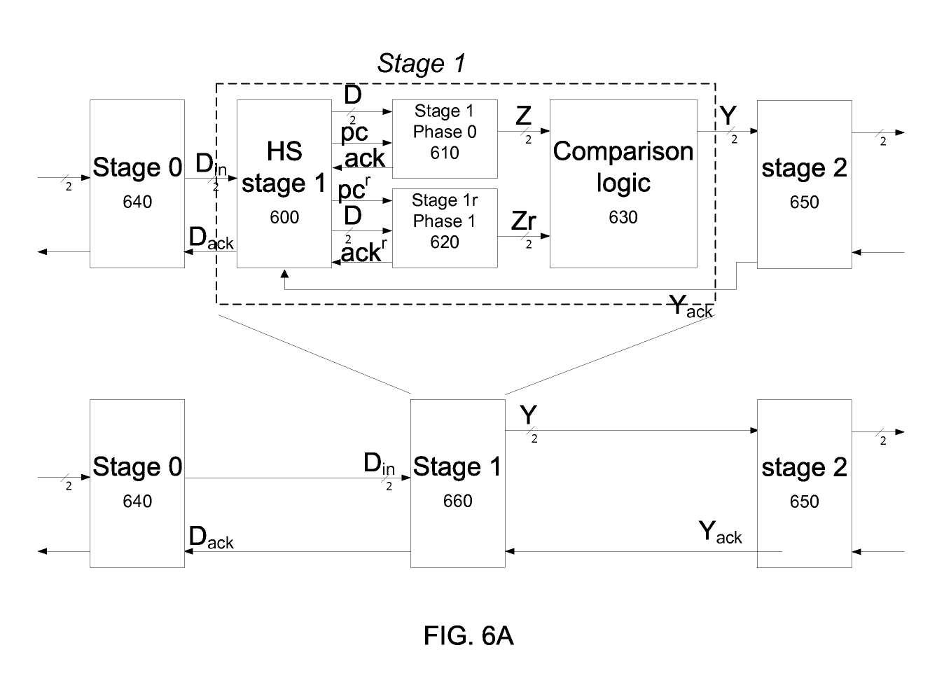

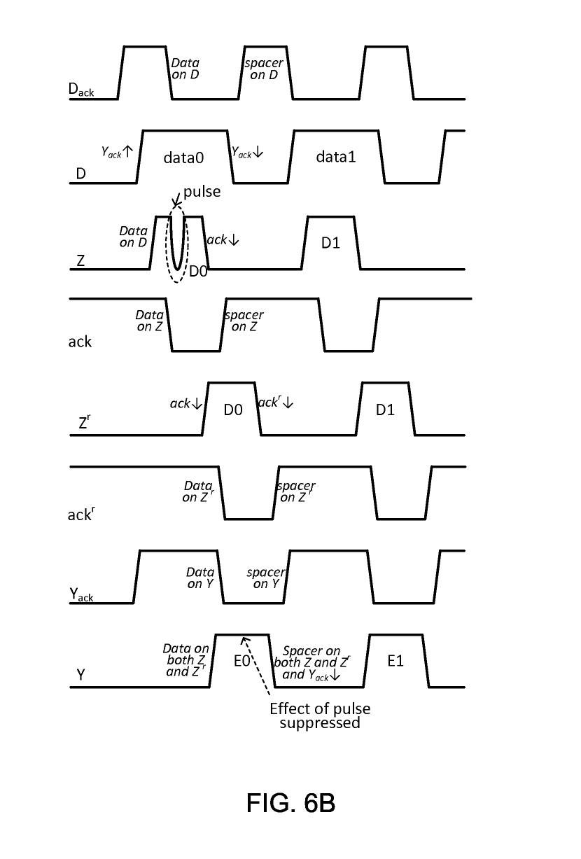

FIG. 6A shows a first embodiment that may be used to perform error checking using the dual parallel pipeline approach described above. In this embodiment, three stages; Stage 0 640; Stage1 660 and Stage2 650; are shown. However any number of stages may be included. In this example, Din is encoded using a dual rail encoding—either a two phase or four phase protocol may be used. Furthermore, an expanded view of stage1 660 is shown, where the Stage1 660 includes a HS Stage1 600, dual pipelines 610, 620, and comparison logic 630. Data from Stage0 640 enters Stage1 660, and more specifically, the HS Stage1 600. The data is then split into two stages 610, 620, each out of phase with the other. However, unlike the embodiment described above, both pipelines (Stage 1 610 and Stage 1r 620) contain exactly the same data. In other words, rather than processing different data in each pipeline, the embodiment of FIG. 6A processes the same data on both pipelines 610, 620. Thus, under normal conditions, the output from Stage 1 610 should always match the output from Stage 1r 620, although it is out of phase temporally.

As noted above, the dual pipelines 610, 620 are fed with data from HS Stage1 600. The HS Stage1 600 includes the data and a pc, or precharge, signal. It receives ack signals from the two pipelines 610, 620.

The outputs from the dual pipelines (Stage 1 610 and Stage 1r 620) each enter the comparison logic 630. The comparison logic 630 compares the outputs of the Stage 1 610 and Stage 1r 620 pipelines. When the outputs agree, the comparison logic 630 propagates the value to the outputs—Y. When the outputs disagree, the comparison logic 630 holds the previous output value. Eventually the error is dissipated or corrected causing the comparison logic 630 to determine that the Z values agree. It then propagates this new data value to Y and to Stage2 650.

FIG. 6B shows a representative timing diagram showing the operation of the circuit of FIG. 6A. As described above, Stage 1 610 and Stage 1r 620 operate out of phase with one another. The general behavior is as follows. The HS Stage1 600 passes data, D, to the phase 0 portion 610 of the dual pipeline and asserts the signal pc to cause the Stage 1 610 (phase 0) to enter evaluation. The Stage 1 610 processes the input D causing Z to reflect the new processed data (D0). At the same time, the Stage 1r 620 (phase 1) receives the data and the complement of the pc signal. Because Stage 1r 620 receives the complement of the pc signal, which at this point in time indicates a spacer, the Stage 1r 620 outputs a spacer to Z^{r}. The Stage 1 610 contains logic to sense the completion of data processing. When this completion circuit senses that data processing has completed, it deasserts the ack signal to the HS stage1 600. This indicates to HS stage1 600 that it should now pass D0 to the redundant stage (i.e. Stage 1r 620) for processing. This is accomplished by inverting the pc signal. The pc signal is low, indicating to Stage 1 610 that it should process a spacer causing Z to transition to a spacer. A low pc signal indicates to the Stage 1r 620 that it should start processing data. After a delay, Z^{r} reflects the processed data (D0). When Stage 1r 620 has finished processing data, it deasserts the ack^{r} signal, which signals to its HS stage1 600 that both dual pipelines have finished computation so the HS stage1 600 prepares for processing the next data set. Since both stages 610, 620 have processed D0, the comparison logic 630 compares the data carried in Z and Z^{r}. The comparison logic 630 essentially samples the Z data, and holds it until the Z^{r} data is available. It then compares it to the Z^{r} data. Specifically, the HS Stage1 600 generates pc signals that control when Stage 1 610 and Stage 1r 620 are evaluating data. Based on these pc signals, the comparison logic 630 knows how long the data in each stage is considered valid. So when pc is high, Stage 1 610 is evaluating. The comparison logic 630 continuously samples the Z data. This Z data may contain a glitch. The comparison logic 630 can only determine whether it is a glitch by comparing it against the redundant copy since the glitch is temporal. When pc goes low, pc_r is asserted, causing Stage 1r 620 to evaluate the data. For the duration that pc_r is high, the comparison logic 630 compares the already sampled Z data against the Z^{r} data. If at any time, a Z sample disagrees with its corresponding Z^{r} sample, the comparison logic 630 does not propagate the disagreed value to the output and holds the previous output. Assume, for example, the glitch appears at the very start of Z^{r} data. For the duration of the glitch, the two stages will disagree so the comparison logic 630 holds the previous output value, which would be a spacer. The glitch will dissipate causing Z^{r} data to be valid logic that agrees with sampled Z. The comparison logic 630 then propagates this value to the output. When examining the output data from the comparison logic 630, it appears to be delayed in time with the amount of delay corresponding to the time it takes to resolve the glitch.

Thus, if glitches occur during the processing of Z (as shown in FIG. 6B), these values are not captured by the comparison logic 630, as the comparison logic 630 only captures the Z data when the ack is deasserted by the Stage 1 610. Glitches that occur during Z^{r} data are ignored, as these glitches will cause the Z data and the Z^{r} data not to match. The comparison logic 630 will only pass the output, Y, when both the sampled Z and the Z^{r} data agree.

As stated above, only the values of Z and Z^{r} that are the same propagate to the output Y. Thus, when Z and Z^{r} agree, the output Y assumes that value. At all other times, it retains its previous value. When new data enters Stage2 650, it deasserts Yack, which allows HS Stage1 600 to output a spacer. When a spacer appears at Stage2 650, it asserts the Yack signal, causing the HS Stage1 600 to move to the next data set.

In the example shown in FIG. 6B, a spurious pulse has afflicted Z, causing it to appear to be the spacer state for a brief period. However, for the glitch to affect the output of the comparison logic 630, both Z and Z^{r} must both be affected. Therefore, this glitch is ignored. If the glitch occurred on the Z^{r} data, the ‘data’ values of Z and Z^{r} would not agree for the entire duration of the D0 data on the Z lines, and the comparison logic 630 would reject the spurious pulse and only propagate the values that agree (D0). When data has propagated to Y (as E0), Y_{ack} lowers. Eventually, Z and Z^{r} enter the spacer state because of ack and ack^{r}, respectively. These actions combined with a low Yack causes Y to enter the spacer state. The spacer on Y will get processed by stage2 650 causing stage2 650 to raise Y_{ack}. The rise of Y_{ack} causes the entire cycle to repeat.

In addition, by operating the redundant Stage 1r out of phase, the current draw from the power supply exhibits a smoother profile. This reduces the potential for electromagnetic interference problems and improves the resilience of the system to side channel attacks such as power analysis and EM analysis.

While this embodiment provides fault tolerance, it should be noted that the throughput of the circuit is not improved by the use of the dual pipelines. In fact, the overall speed of the FPGA is slowed due to the presence of the checking and error correction logic.

Fault Tolerance and Speed Improvement

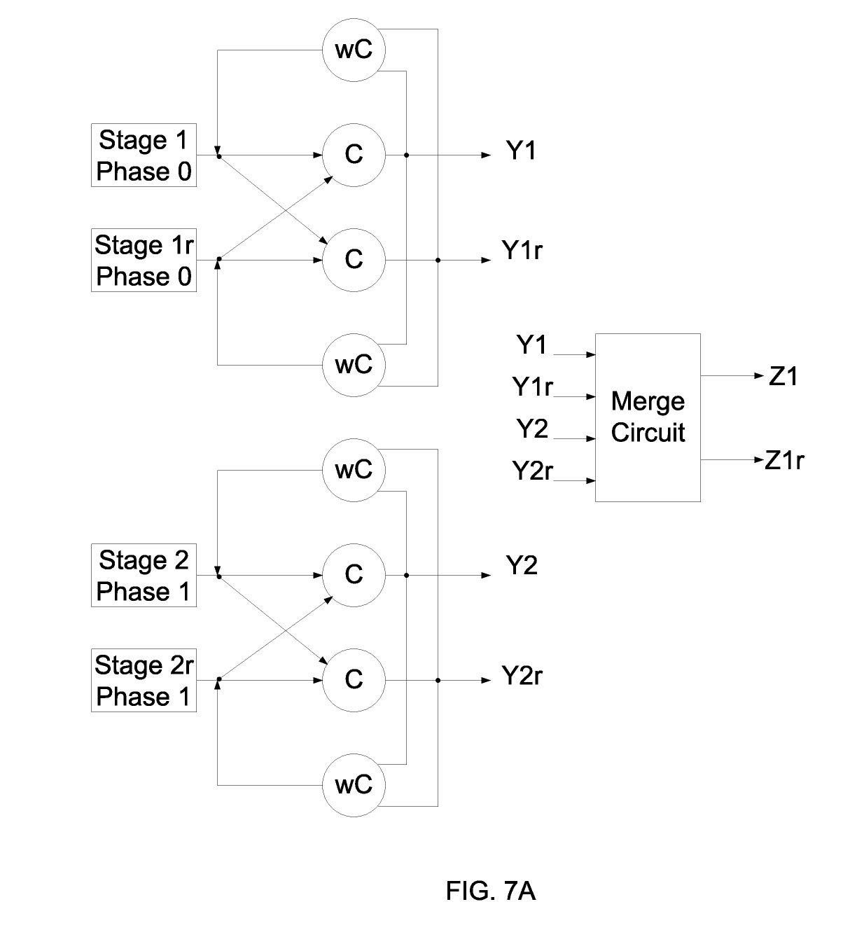

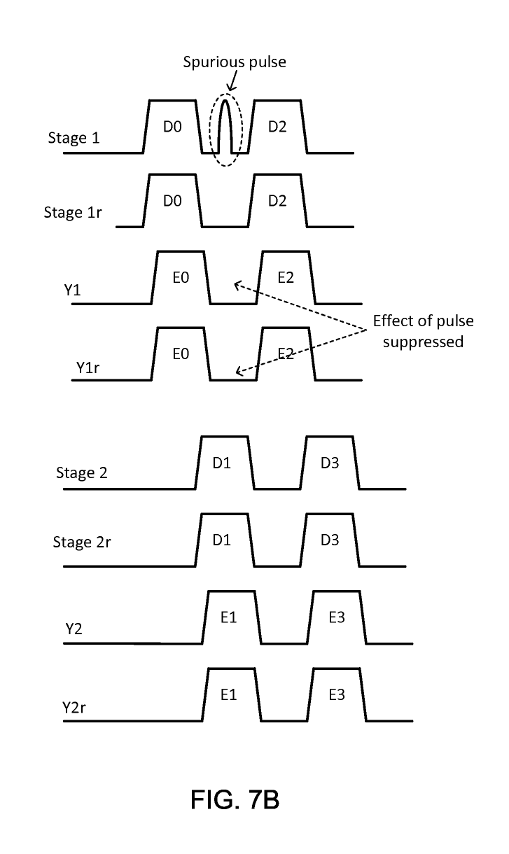

FIG. 7A shows a second embodiment that may be used to perform error checking using the dual parallel pipeline approach described above. In this embodiment, the data is split into two stages (see FIG. 5A), each out of phase with the other. Each of these stages is then replicated, thereby creating the Stage 1r and Stage 2r pipelines. These two additional stages are exact replicas of the Stage 1 and Stage 2 pipelines, respectively. Thus, under normal conditions, the output from Stage 1 should always match the output from Stage 1r, and likewise for Stage 2 and Stage 2r. In addition, the output from Stage 2 should be out of phase with the output from Stage 1.

In other words, this embodiment utilizes the input stage, the first converter, the second converter and the output stage described above. In addition, this embodiment also includes the dual pipeline stage, where the two pipelines operate out of phase with one another. In addition, each of the pipelines comprises two redundant paths.

The outputs from the redundant paths (Stage 1 and Stage 1r) each enter two C-gates. A C-gate is a function which has an output of 1 if both inputs are 1. The C-gate has an output of 0 if both inputs are 0. In all other scenarios, the output of the C-gate remains unchanged. Thus, the outputs of the C-gates reflect the outputs of the redundant paths (Stage 1 and Stage 1r) when the outputs from the paths agree. In the case of an error, as shown in FIG. 7B, the C-gates retain the previous output until the outputs of the two paths of the pipeline agree. As shown in FIG. 7B, Data D0 is presented on both Stage 1 and Stage 1r. Therefore, the outputs Y1 and Y1r change to reflect E0, which is equal to data D0. The spurious pulse experienced by Stage 1 is ignored, since it does not match the data on Stage 1r. Next, data D2 is presented on both Stage 1 and Stage 1r, and that output E2 is presented on T1 and Y1r.

Redundant paths (Stage 2 and Stage 2r) of the second pipeline operate in a similar fashion, simply out of phase with the Stage 1 and Stage 1r pipelines. The outputs from the two pipelines are then merged together, using the merge circuit described in FIG. 5E.

In some embodiments, a second set of C-gates, referred to as weak C-gates (wC), are introduced and provide a feedback path back to the outputs of the Stage 1 and Stage 1r. These weak C-gates may help restore the correct state of the Stages more expeditiously than if not present. However, in other embodiments, these weak C-gates are not used.

The same circuitry is used for Stage 2 and Stage 2r. The outputs from these two circuits then enter a merge circuit, which coalesces the data streams. This embodiment maintains roughly the same throughput as the non-redundant version shown in FIG. 5A. However, the number of transistors may be almost twice as many as the embodiment of FIG. 5A due to the replication of all of the pipelined stages.

Embodiment employing dual pipelines for fault tolerance are immune to single bit errors. To reduce the likelihood of multiple bit errors, the redundant pipelines may be separated spatially by placing the transistors associated with each pipeline at least 10 μm apart. This can be accomplished via design and routing rules used to fabricate the device. For example, as shown in FIG. 4, the device comprises a plurality of CLBs, which are separated by routing channels, CBs and SBs. The redundant pipelines may be disposed in different CLBs which are the required distance apart.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An asynchronous circuit comprising:
an input stage;
a first converter;
a dual pipeline stage;
a second converter; and
an output stage;
wherein said first converter separates data from said input stage into alternating pipelines of said dual pipelines; and said second converter merges data from said dual pipeline stage back into said single output stage.

2. The asynchronous circuit of claim 1, wherein the format of data entering said input stage is the same as the format of data in said dual pipeline stage.

3. The asynchronous circuit of claim 1, wherein the format of data entering said input stage is different from the format of data in said dual pipeline stage.

4. The asynchronous circuit of claim 1, wherein said dual pipeline stage utilizes 4-phase signaling.

5. The asynchronous circuit of claim 4, wherein said input stage utilizes 2-phase format.

6. The asynchronous circuit of claim 5, wherein said first converter separates said data in 2-phase format into two independent 4-phase pipelines.

7. The asynchronous circuit of claim 6, wherein said second converter assembles said two independent 4-phase pipelines into a single output utilizing 2-phase signaling.

8. The asynchronous circuit of claim 4, wherein said input stage utilizes 4-phase signaling.

9. The asynchronous circuit of claim 8, wherein each of said dual pipelines operates at half speed of said input stage.

10. The asynchronous circuit of claim 1, wherein said asynchronous circuit is disposed within a FPGA and said input stage and said output stage communicate with a Connection Block (CB) or a switching block (SB); and said dual pipeline stage is disposed in a configurable logic block (CLB).

11. The asynchronous circuit of claim 1, wherein said pipelines of said dual pipeline stage operate out of phase with each other.

12. A fault tolerant asynchronous circuit, comprising:
an input stage;
a first converter;
a dual pipeline stage;
a logic comparator to compare outputs from each pipeline of said dual pipeline stage; and
an output stage to receive an output from said logic comparator;
wherein said first converter receives data from said input stage and provides the same data element to each of said pipelines of said dual pipeline stage; and said dual pipelines operate out of phase with one another.

13. The fault tolerant asynchronous circuit of claim 12, wherein an output of said logic comparator changes when outputs of said two pipelines agrees and remains unchanged when said outputs differ.

14. The fault tolerant asynchronous circuit of claim 12, wherein 4-phase signaling is used to transmit data.

15. A fault tolerant asynchronous circuit comprising:
an input stage;
a first converter;
a dual pipeline stage, wherein each of said pipelines operates out of phase with each other and each pipeline comprises two redundant paths;
a logic comparator to compare outputs from each redundant path of each pipeline and generate an output for each pipeline;
a second converter; and
an output stage;
wherein said first converter separates data from said input stage into alternating pipelines of said dual pipelines; and said second converter merges outputs from said logic comparator into a single output stage.

16. The fault tolerant asynchronous circuit of claim 15, wherein an output of said logic comparator changes when outputs of said two paths of said pipeline agree and remains unchanged when said outputs differ.

17. The fault tolerant asynchronous circuit of claim 15, wherein the format of data entering said input stage is the same as the format of data in said dual pipeline stage.

18. The asynchronous circuit of claim 15, wherein the format of data entering said input stage is different from the format of data in said dual pipeline stage.
